(19) United States
(12) Patent Application Publication
(10) Pub. No.: US 2017/0193204 A1
(43) Pub. Date: Jul. 6, 2017

(54) CONTROL DEVICE, CONTROL METHOD THEREFOR, AND COMPUTER-READABLE RECORDING MEDIUM

(71) Applicant: NEC Soluton Innovators, Ltd., Tokyo (JP)

(72) Inventors: Yukio NISHIDA, Tokyo (JP); Noriyoshi HIROI, Tokyo (JP)

(21) Appl. No.: 15/315,323

(22) PCT Filed: May 18, 2015
(86) PCT No.: PCT/JP2015/002498

§ 371 Date: Nov. 30, 2016

(30) Foreign Application Priority Data
May 30, 2014 (JP) 2014-113005

(51) Int. Cl. G06F 21/12; G06F 13/10; H04L 9/32; G06F 21/60; H04L 9/08; G06F 21/44; G06Q 30/06; H04N 21/266

(52) U.S. Cl. CPC G06F 21/121; G06Q 30/06; G06F 13/10; H04N 21/266; G06F 21/60; H04L 9/08; G06F 21/44; H04L 9/32; G06F 21/12; G06F 2221/2135

(57) ABSTRACT

Provided are a content control device, a control method therefor, and a program, with which the usage of digital content can be controlled appropriately.

This content control device 100 is equipped with: a storage unit 102 that stores, for each content, the provided count (which is an instance count of the content being provided at a given point in time), and the providable count of the content; a provision determination unit 104 that, based on the provided count and the providable count, determines whether object content can be provided to a candidate device that receives the provided object content; and a provision count management unit 106 that, when the object content is provided to the candidate device 12 in accordance with the determination result from the provision determination unit 104, adds the provided count stored in relation to the object content.

### TECHNICAL FIELD

The present invention relates to a content control device, a control method therefor and a computer-readable recording medium, and particularly relates to a content control device, a control method therefor and a computer-readable recording medium with which the provision of content is controlled.

### BACKGROUND ART

In recent years, there has been a growth of services for browsing digital content such as an electronic book or an electronic comic with a mobile terminal such as a tablet terminal or a smartphone.

In the case where digital content is paid, it is desirable that the content be available only to users who purchased the content. There are technologies such as DRM (Digital Rights Management) that are designed to prevent illegal copying and distribution.

PTL 1 describes one example of a content management method capable of preventing illegal browsing of digital content using such technologies. The content management method described in PTL 1 realizes a mechanism of content distribution equipped with DRM that allows browsing of one item of purchased content with a plurality of terminals.

### CITATION LIST

### Patent Literature

[PTL1] Japanese Laid-open Patent Publication No. 2011-221999

### SUMMARY OF INVENTION

### Technical Problem

Along with the increase of hotspot installations and the like around town, a continued increase is expected in the various forms of providing various services in the future, such as a service with which a game software can be lent to a mobile terminal such as a game console of a user at a manga café, an Internet cafe, or the like and played on the spot.

With such a background, efforts to protect and facilitate the appropriate use of digital content copyright are an important issue.

The present invention has been made in view of the above circumstance, and an object is to provide a content control device, a control method therefor, and a computer-readable recording medium with which the use of digital content is controlled appropriately.

### Solution to Problem

In order to solve the issue described above, each of the following configurations is employed in each aspect of the present invention.

A first aspect relates to a content control device. The content control device according to the first aspect includes

storage means for storing, for each content, a provided count and a providable count of the content, the provided count representing instance count of the content being provided at a given point in time;

provision determination means for determining whether to provide a object content to a candidate device being subject to receive the object content based on the provided count and the providable count; and

provision count management means for adding instance count of the object content newly provided to the provided count stored with respect to the object content when the object content is provided to the candidate device in accordance with a determination result from the provision determination means.

A second aspect relates to a control method executed by at least one computer. The control method according to the second aspect includes

storing, for each content, a provided count and a providable count of the content, the provided count representing instances count of the content being provided at a given point in time;

determining whether to provide a object content to a candidate device being subject to receive the object content based on the provided count and the providable count; and

adding instance count of the object content newly provided to the provided count stored with respect to the object content when the object content is provided to the candidate device in accordance with a result the determination.

Another aspect of the present invention may be a program that causes at least one computer to execute the method in the second aspect above or may be a computer-readable recording medium recording such a program. The recording medium includes a non-transitory tangible medium.

The program includes a program code that causes a computer to carry out, on a content control device, a control method therefor, when executed by the computer.

Any combination of the above components and expressions of the present invention that have been converted to and from a method, a device, a system, a recording medium, a program, or the like are also valid as an aspect of the present invention.

Various components of the present invention do not necessarily need to be present individually and independently. It may be such that a plurality of components are formed as one member, one component is formed as a plurality of members, a certain component is a part of another component, a part of a certain component and a part of another component overlap, or the like.

For the method and program of the present invention, a plurality of procedures are described in order. However, the described order does not limit the order in which the plurality of procedures are executed. Therefore, when carrying out the method or program of the present invention, the order of the plurality of procedures may be changed, unless the workings are compromised.

Further, the plurality of procedures in the method and program of the present invention are not limited to being executed each at different timings. Therefore, it may be such that another procedure occurs during execution of a certain procedure, a timing for execution of a certain procedure and a timing for execution of another procedure partially or entirely overlap, or the like.

### Advantageous Effects of Invention

With the respective aspects above, a content control device, a control method therefor and a computer-readable recording medium with which the use of digital content is controlled appropriately can be provided.

### BRIEF DESCRIPTION OF DRAWINGS

FIG. 1 is a diagram schematically illustrating the system configuration of a content providing system 1 controlled by a content control device according to an example embodiment of the present invention.

FIG. 2 is a functional block diagram illustrating the logical configuration of the content control device according to the example embodiment of the present invention.

FIG. 3 is a block diagram illustrating a configuration example of a computer realizing the content control device of this example embodiment.

FIG. 4 is a diagram illustrating an example of information stored in the content control device of this example embodiment.

FIG. 5 is a flowchart illustrating one example of the operation of the content control device of this example embodiment.

FIG. 6 is a sequence diagram illustrating a content providing procedure in the content providing system of this example embodiment.

FIG. 7 is a sequence diagram illustrating a content providing procedure in the content providing system of this example embodiment.

FIG. 8 is a diagram illustrating one example of a screen for the content providing device of this example embodiment to notify a candidate device of a restriction of use of object content.

FIG. 9 is a functional block diagram illustrating the logical configuration of a content control device according to an example embodiment of the present invention.

FIG. 10 is a flowchart illustrating one example of the operation of the content control device of this example embodiment.

FIG. 11 is a functional block diagram illustrating the logical configuration of the content control device of this example embodiment.

FIG. 12 is a diagram illustrating an example of information stored in the content control device of this example embodiment.

FIG. 13 is a flowchart illustrating one example of the operation of the content control device of this example embodiment.

FIG. 14 is a functional block diagram illustrating the logical configuration of a content control device according to an example embodiment of the present invention.

FIG. 15 is a flowchart illustrating one example of the operation of the content control device of this example embodiment.

FIG. 16 is a functional block diagram illustrating the logical configuration of the content control device of this example embodiment.

FIG. 17 is a diagram schematically illustrating the system configuration of a content providing system including the content control device of this example embodiment.

FIG. 18 is a view illustrating an example of a projection image being projected by a projection device to which the provision of content is controlled by the content control device of this example embodiment.

FIG. 19 is a diagram illustrating one example of a projection image from the projection device to which the provision of content is controlled by the content control device of this example embodiment.

### DESCRIPTION OF EMBODIMENTS

Example embodiments of the present invention will be described below using the drawings. For all of the drawings, similar components are denoted by similar reference signs, and description will be omitted as appropriate.

### First Example Embodiment

A content control device, a control method therefor and a program according to a first example embodiment of the present invention will be described below.

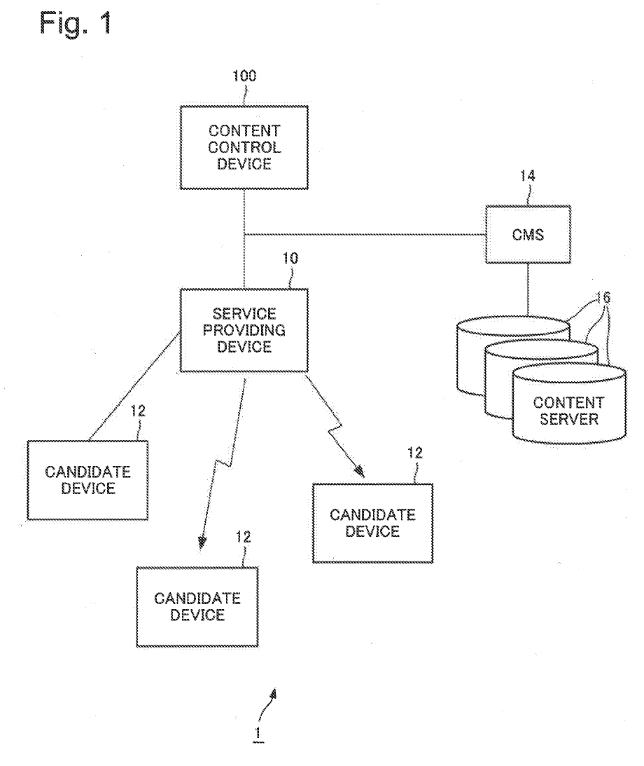

FIG. 1 is a diagram conceptually illustrating the system configuration of the content providing system 1 including a content control device 100 according to the example embodiment of the present invention.

In this example embodiment, the content providing system 1 provides the use of digital content as a service with respect to a specified or unspecified user in a specific area, such as, for example, a public place, a shop, or a shopfront. In this example embodiment, an object content includes various digital content such as an electronic book, music, a video, a game, or an application which are available to a user via a candidate device 12.

The content providing system 1 provides the object content to the candidate device 12. In this description, the candidate device 12 is a device that can receive the object content, e.g., a mobile terminal that can be operated by each user, a digital signage or a projector placed in a specific area, or the like. Accordingly, the object content is provided to allow use by a user via the candidate devices 12. For example, a projector placed in a specific area can project an image on a body, a floor, a wall, a table or the like as a projection surface, and detect, using a three-dimensional sensor, an operation such as a gesture or the like of a human or operated object to realize a user interface.

A mobile terminal included in the candidate device 12 of this example embodiment includes, for example, a smartphone, a tablet terminal, an electronic book reader terminal, a mobile digital music player, a portable video player, a notebook personal computer, a mobile phone, a PHS (Personal Handyphone System), PDA (Personal Digital Assistants), a game console, a television receiver, and the like, and is not particularly limited as long as the terminal is a portable terminal which allows for the use of digital content. The mobile terminal may be owned by a user or may be lent.

In an example of FIG. 1, the content providing system 1 includes a service providing device 10 that provides a user with various services or the like including a service of providing a user with digital content, a content server 16 that is a distribution source and stores digital content, and a content management server 14 (CMS: Contents Management System) with which digital content stored in the content server 16 is managed and distributed to the service providing device 10. The system configuration in FIG. 1 is one example, and the present invention is not limited as such. For each figure below, the configuration of portions not substantially relevant to the present invention will be omitted and not shown.

The service providing device 10 provides, in coordination with the content control device 100, a service with which a user can use the object content via the candidate device 12. In an example of a case where the candidate device 12 is a mobile terminal of a user, the service providing device 10 can provide a service with which music can be listened to on the mobile terminal of the user. In an example of a case where the candidate device 12 is a projector, the service providing device 10 can provide a service with which an electronic book is projected with the projector and browsed by a user.

In the example of FIG. 1, the service providing device 10 serves a function of providing a service with which the object content is used by a user via the candidate device 12, and the content control device 100 serves a function of controlling whether the object content that the service providing device 10 causes a user to use via the candidate device 12 can be provided or can be used.

In the example of FIG. 1, the service providing device 10 and the content control device 100 are illustrated as different devices, but may be realized as one content control device, considering the coordination of operation.

The content control device 100 permits the temporary use of content by a user. For example, the content control device 100 temporarily permits a user present in a specific area to use the object content. The content control device 100 restricts the number of users that can use one item of the object content at a given point in time to a providable count. In other words, in relation to each of the object content, the content providing side (content providing system 1 side) holds licenses corresponding to that providable count.

When the candidate device 12 is placed in a specific area, as with a projector or the like, the use of digital content is automatically limited to the specific area. Therefore, a special mechanism for the temporary use may not be required. However, in the case where the candidate device 12 is a mobile terminal, a function of permitting the temporary use of digital content by a user or prohibiting the permanent use of content is necessary. Various methods to realize this are conceivable. Examples are illustrated below, but are not limiting.

(1) Install a dedicated application for using digital content on a mobile terminal, and provide digital content in a file format that can be used only with the dedicated application.
(2) Install a dedicated application for using digital content on a mobile terminal, prohibit saving of digital content provided to the mobile terminal into storage of the mobile terminal, keep to storing the content in a RAM (Random Access Memory), and realize with the application a function of deleting the content off the RAM upon the termination of use of the content.
(3) Play digital content on a mobile terminal through streaming distribution, and prohibit saving into a content file on the mobile terminal.
(4) Execute digital content of an application, such as a game, on a server on the content server 16 or content management server 14 side without download of the digital content to a mobile terminal, so that digital content is used online through access to the server from the mobile terminal.

In this example embodiment, the content control device 100 controls the provision of digital content by the service providing device 10. For example, the content control device 100 permits or prohibits the provision of digital content to the candidate device 12 by the service providing device 10 or causes the provision of digital content to be suspended. Controlling the provision of a digital content includes controlling the use of the digital content by a user via the candidate device 12. An example of such control is, in the case where a data file of digital content is downloaded to a mobile terminal as the candidate device 12, the content control device 100 rendering the data file unusable. In this case, the content control device 100 can send an indication to disallow use to the candidate device 12.

Content may be distributed to the candidate device 12 from the service providing device 10 as illustrated in FIG. 1, or may be directly distributed to the candidate device 12 from the content management server 14 by the service providing device 10 making an indication to the content management server 14.

Alternatively, the service providing device 10 and the content management server 14 may be integrated. The service providing device 10 and the content management server 14 need not be in a one-to-one relationship. Various configurations of one-to-N, N-to-one, N-to-M, and the like are conceivable.

There may be at least one of a wired or wireless connection between respective devices of the service providing device 10, the candidate device 12, the content control device 100, and the content management server 14. Means of connection is not particularly limited, and various forms are conceivable.

In this example embodiment, an example will be described of a case including both a wired (e.g., LAN (Local Area Network) or USB (Universal Serial Bus)) connection and a wireless communication (e.g., wireless LAN (Local Area Network)) connection between the service providing device 10 and the candidate device 12. When the candidate device 12 is a device including communication means for performing communication via various public networks such as 3G (3rd Generation), LTE (Long Term Evolution) and WiMAX (Worldwide Interoperability for Microwave Access), a configuration to allow for communication with the service providing device 10, the content control device 100 or the content management server 14 via the public networks is also included.

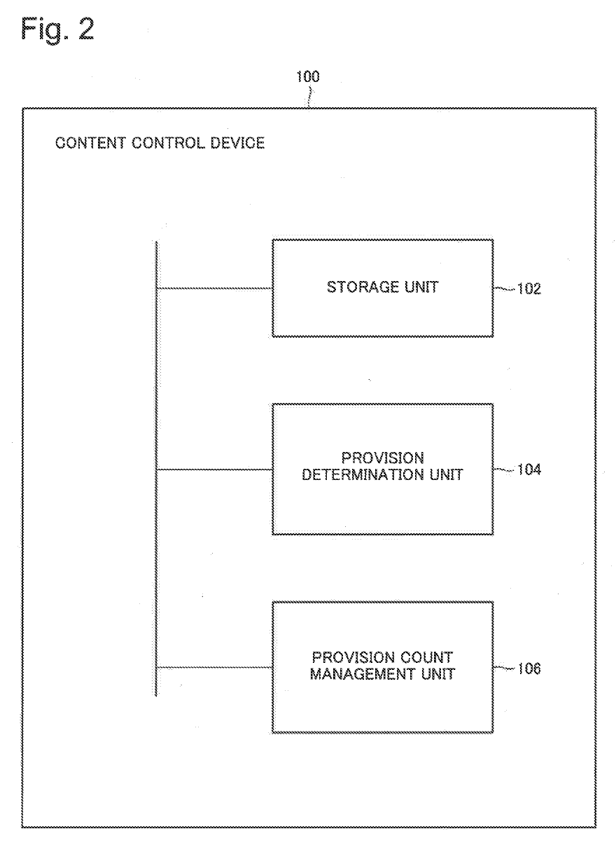

FIG. 2 is a functional block diagram showing the logical configuration of the content control device 100 according to the example embodiment of the present invention.

The content control device 100 includes a storage unit 102 and a provision count management unit 106. The storage unit 102 stores, for each content, the provided count which is the number of instances of the content being provided at a given point in time and the providable count of the content. A provision determination unit 104 determines, on the basis of the provided count and the providable count, whether the object content can be provided to the candidate device 12 that receives the object content. In the case where the object content is provided to the candidate device 12 in accordance with the determination result from the provision determination unit 104 and the provision determination unit 104, the provision count management unit 106 adds the provided count stored in relation to the object content.

The storage unit 102 stores, for each content, the provided count which is the number of instances of the content being provided at a given point in time, and the providable count of the content at a given point in time. In this description, this provided count and this providable count will be hereinafter referred to as the count of current provision and the allowed count of current provision respectively. The allowed count of current provision means the maximum number of possible instances of providing the object content simultaneously to the candidate device 12 permitted by the distribution source of content. It is also possible that the allowed count of current provision is the number of licenses purchased from the distribution source of content. The count of current provision is the number of instances of the content being provided to the candidate device 12 at a given point in time.

“current provision” herein is not limited to a case where a period for providing a certain content from start to termination is exactly the same. For example, “current provision” means a state where periods for providing one item of content to each of a plurality of different candidate devices 12 overlap at least slightly. Note that the meaning of “current provision” is not limited as such, and “current provision” may have an added condition, such as an overlapping time being longer than a predetermined threshold value. “The provision of the object content to the candidate device 12” means that a part or all of the object content is sent to the candidate device 12. A part of the object content being sent to the candidate device 12 is a case where only an image of a browsed (opened) page of an electronic book is sent to the candidate device 12, a case where, upon playing an online game, an image for the game is sent to the candidate device 12 instead of an application of the game being sent to the candidate device 12, a case where music or an image is streamed to the candidate device 12, or the like.

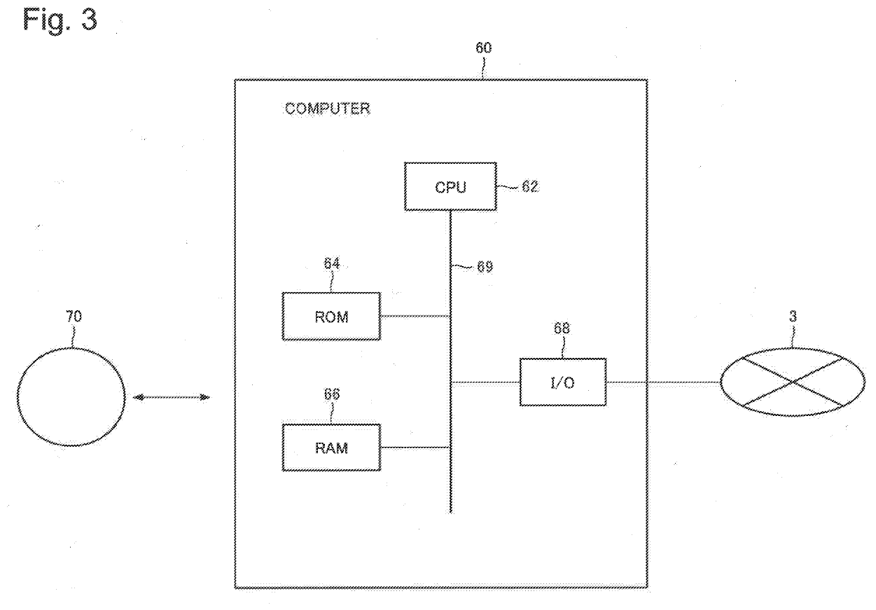

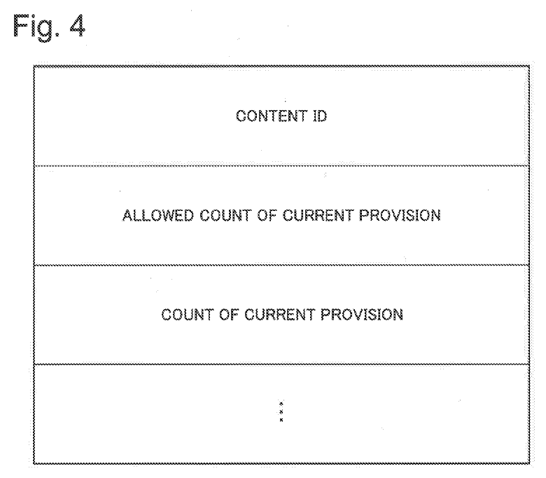

As illustrated in FIG. 4, the storage unit 102 may store, for each content, the count of current provision and the allowed count of current provision in association with identification information (ID) of the content. The information may be stored in a ROM (Read Only Memory) 64, a RAM (Random Access Memory) 66, or storage (not illustrated) of a computer 60 in FIG. 3 as described later. In FIG. 4, information is stored in a table format. However, the table structure is not limited as such, and it is not necessary that the information is stored in a table format. The information may be stored as a parameter, variable, or the like.

In this example embodiment, the count of current provision and the allowed count of current provision are stored for “each content,” but not limited to that. In a case where the content is a magazine, the same magazine may be treated as the same content even when the month of sale differs, or may be treated as a different content for each month of sale. For music, a plurality of tracks within an album by the same artist or having one title may be treated as the same content. In other words, setting may be pursuant to the terms of license.

In this example embodiment, the storage unit 102 may store information other than the “allowed count of current provision.” For example, the storage unit 102 may store various restriction information such as restriction information on the allowed period of provision, restriction information on the total number of times of provision or restriction information on the time (or period) of provision. Other types also suffice as long as the details of restriction and the situation of provision can be acquired and stored in a similar manner.

The provision determination unit 104 determines, on the basis of the count of current provision and the allowed count of current provision stored in the storage unit 102, whether the object content can be provided to the candidate device 12 that receives provision of the object content. In this example embodiment, the provision determination unit 104 determines to permit the provision of the object content in the case where the count of current provision is less than or equal to the allowed count of current provision, and determines to prohibit the provision of the object content in the case where the count of current provision has exceeded the allowed count of current provision.

In the case where the object content is provided to the candidate device 12 in accordance with the determination result from the provision determination unit 104, the provision count management unit 106 adds the count of current provision stored in relation to the object content. The count of current provision increases by the provided count of the object content.

In this example embodiment, the provision count management unit 106 makes an instruction to the service providing device 10 or the content management server 14 that the provision of the object content to the candidate device 12 is permitted, in the case where the object content is to be provided to the candidate device 12. Alternatively, the provision count management unit 106 may make an instruction to the candidate device 12 that has made a request for use of the object content that the use of the object content is permitted. Upon receiving the instruction, the service providing device 10 or the content management server 14 carries out the provision of the object content to the candidate device 12. Alternatively, the candidate device 12 uses the object content according to the instruction.

FIG. 3 is a block diagram illustrating a configuration example of the computer 60 achieving the content control device 100.

The computer 60 includes a CPU (Central Processing Unit) 62, a memory (the ROM 64 and the RAM 66), a program loaded to the memory to realize a component in FIG. 2, storage (not illustrated) such as a hard disk storing the program, and a network connection interface (I/O (Input/Output) 68). The ROM 64, the RAM 66 and the I/O 68 are connected with each other via a bus 69, and the entire content control device 100 is controlled together with respective components in FIG. 2 by the CPU 62.

The respective components of the content control device 100 of the example embodiment in FIG. 2 are achieved by a free combination of hardware and software of the computer 60 in FIG. 3. It will be understood to a person in the art that there are a variety of modified examples to a method and device for achieving the content control device 100. Functional block diagrams illustrating a content control device of the respective example embodiments described below illustrate not the configuration in units of hardware but blocks in units of logical functions.

As the CPU 62 of the computer 60 in FIG. 3 reads a program 70 stored in the ROM 64 onto the RAM 66 and executes it, each function of each unit of the content control device 100 in FIG. 2 can be achieved.

The program for this example embodiment is described to cause the computer for realizing the content control device 100 to execute the following procedures. One procedure is a procedure of storing, for each content, the provided count which is the number of instances of the content being provided at a given point in time and the providable count of the content. Another procedure is a procedure of determining, on the basis of the provided count and the providable count, whether the object content can be provided to the candidate device that receives the provided object content. Yet another procedure is a procedure of adding to the provided count stored in relation to the object content when the object content is provided to the candidate device 12 in accordance with the determination result.

The program for this example embodiment may be recorded in a computer-readable recording medium. The recording medium is not particularly limited, and those of various types are conceivable. The program may be loaded to the memory of the computer from the recording medium or may be downloaded to the computer through a network and loaded to the memory.

The recording medium recording the program 70 includes a non-transitory tangible medium usable to the computer 60, and a program code readable to the computer 60 is embedded in the medium. When executed on the computer 60, the program 70 causes the computer 60 to execute a control method below to achieve the content control device 100.

The control method for the content control device 100 of this example embodiment configured in this manner will be described below.

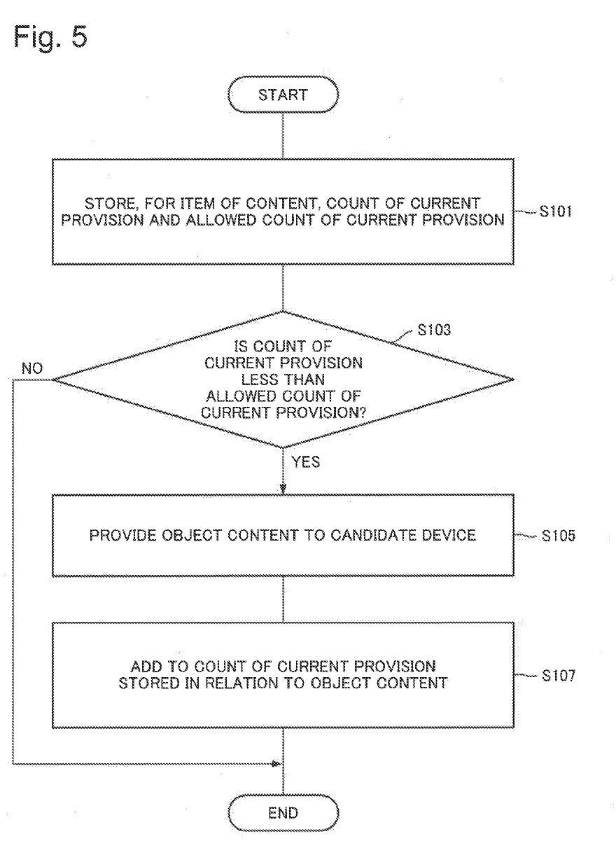

FIG. 5 is a flowchart illustrating one example of the operation of the content control device 100 in this example embodiment.

The control method according to the example embodiment of the present invention is a control method for the content control device 100, and is a control method executed by the computer 60 achieving the content control device 100.

In the control method of this example embodiment, the content control device 100 stores, for each content, the provided count which is the number of instances of the content being provided at a given point in time, and the providable count of the content (step S101). The content control device 100 determines, on the basis of the count of current provision and the allowed count of current provision, whether the object content can be provided to the candidate device 12 that receives the provided object content (step S103). In the case where the object content is provided to the candidate device 12 in accordance with the determination result (step S105), the content control device 100 adds the count of current provision stored in relation to the object content (step S107).

More specifically, in the content control device 100, the storage unit 102 stores, for each content, the count of current provision and the allowed count of current provision (step S101). In step S101, the storage unit 102 saves the allowed count of current provision for each content, after the allowed count of current provision has been determined with respect to each content in pursuance of the terms of license for each content. When the content is provided to the candidate device 12 provision or use of the contents to the candidate device 12 has been stopped, or the like, the count of current provision increases or decreases. Every time the count of current provision increases or decreases, the storage unit 102 updates and stores the count of current provision of the content.

When a use of the content has been requested from the candidate device 12 or the like, the provision determination unit 104 determines whether the count of current provision is less than or equal to the allowed count of current provision (step S103). In the case of the count of current provision being less than the allowed count of current provision (YES in step S103), the provision count management unit 106 provides the object content to the candidate device 12 (step S105). The provision count management unit 106 adds the count of current provision stored with respect to the object content (step S107), and this process terminates. In the case of the count of current provision being greater than or equal to the allowed count of current provision (NO in step S103), the provision of content to the candidate device 12 is not carried out, and this process is terminated. Step S103 of this process is carried out every time a request for use of content is made.

A process procedure for the provision of content by the content control device 100 in the content providing system 1 of this example embodiment will be specifically described below.

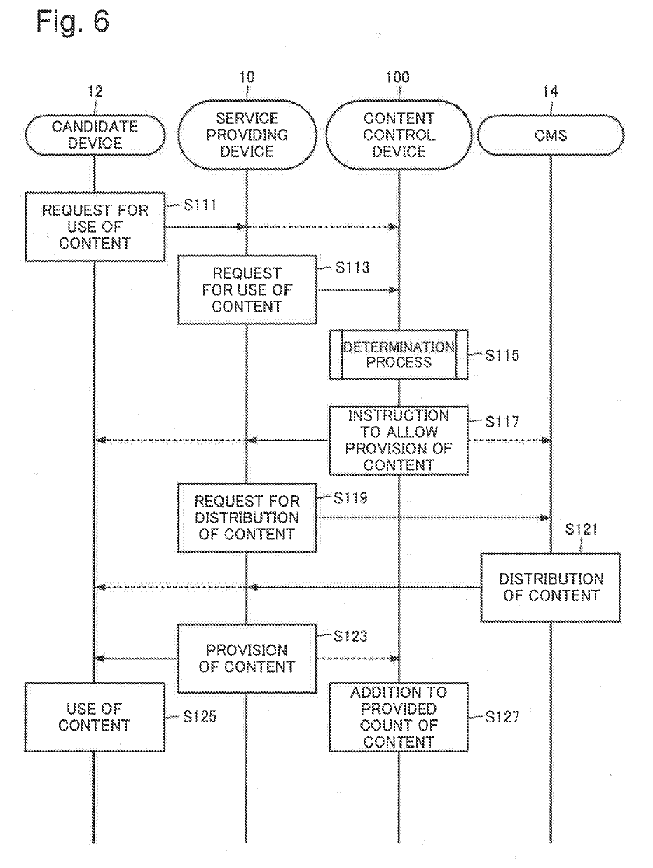

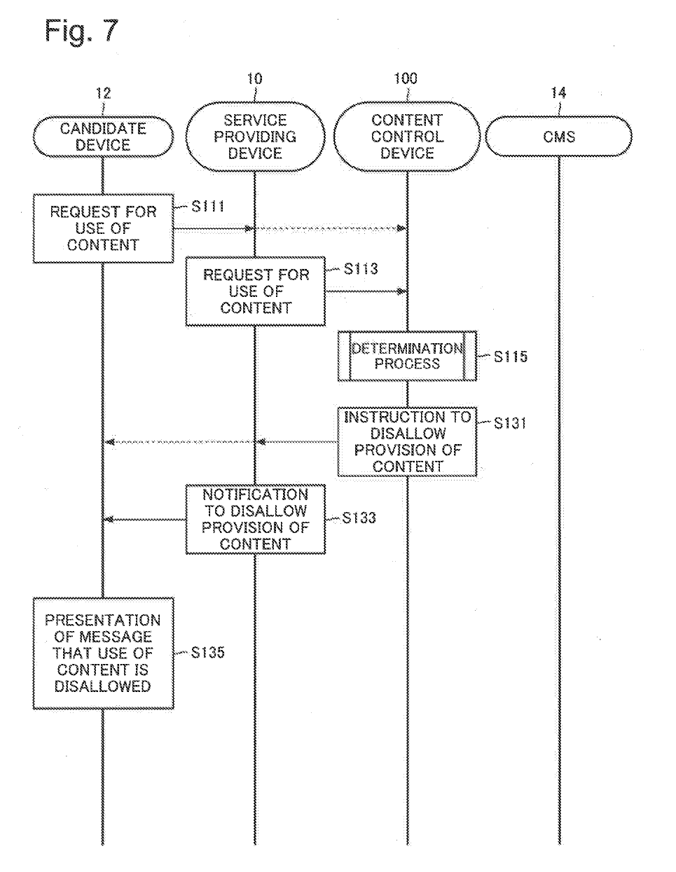

FIG. 6 and FIG. 7 are sequence diagrams illustrating a content providing procedure in the content providing system 1 of this example embodiment. FIG. 6 illustrates a procedure of a case where the provision of the object content is permitted by the content control device 100. FIG. 7 illustrates a procedure of a case where the provision of the object content is not permitted by the content control device 100. Each device waits for receipt of information (such as a request, an indication, or content), determines whether there has been a receipt, and proceeds with the process when it has been determined that there has been a receipt. In FIG. 6 and FIG. 7, the determination processes are not illustrated for the sake of simplifying the explanation, and transfer of information between devices is indicated by an arrow. Dashed arrows indicate other examples of possible flows of information besides the flow of information indicated by solid lines.

First, using FIG. 6, the procedure of a case where the provision of the object content is permitted will be described.

The candidate device 12 requests for use of the object content to the service providing device 10 (step S111). Upon receiving the request for use, the service providing device 10 transfers the request for use from the candidate device 12 to the content control device 100 (step S113). The request for use of content can be made directly to the content control device 100 from the candidate device 12.

In the content control device 100, the provision determination unit 104 executes a determination process illustrated in step S103 in FIG. 2 (step S115). Assume that in FIG. 6, the object content has been determined as providable to the candidate device 12 as a result of the determination process.

The provision count management unit 106 makes an indication, to the service providing device 10, to allow the provision of the object content to the candidate device 12 (step S117). The service providing device 10 makes a request, to the content management server 14, for distribution of the object content to be provided to the candidate device 12 (step S119). Alternatively, the provision count management unit 106 may make an indication, to the content management server 14, to allow the provision of the object content to the candidate device 12. The content management server 14 distributes the object content to the service providing device 10 (step S121). The service providing device 10 provides the object content to the candidate device 12 (step S123), and the candidate device 12 uses the content (step S125). In the content control device 100, the provision count management unit 106 adds the count of current provision of the content (step S127).

Alternatively, in step S117, the provision count management unit 106 may make an instruction to allow the provision of the object content to the candidate device 12. Upon receiving the instruction to allow the provision, the candidate device 12 may wait for the provision of the object content.

In step S121, the content management server 14 may distribute the object content to the candidate device 12. Further, in step S123, the service providing device 10 may notify the content control device 100 that the provision of the content to the candidate device 12 has been carried out. Upon receiving the notification, the content control device 100 may proceed to step S127 and add the count of current provision of the object content.

Next, using FIG. 7, the procedure of a case where the provision of the object content is not permitted will be described.

Herein, the procedure from the request for use of content by the candidate device 12 (step S111) up to the determination process (step S115) in the content control device 100 is similar to that in FIG. 7.

Assume that in FIG. 7, the object content has been determined not to be providable to the candidate device 12 as a result of the determination process by the provision determination unit 104 of the content control device 100.

Upon receiving the determination result, the content control device 100 makes an instruction to disallow the provision of the content to the service providing device 10 or the candidate device 12 (step S131). When the service providing device 10 has accepted the instruction, the service providing device 10 notifies the candidate device 12 to disallow the provision of the content (step S133).

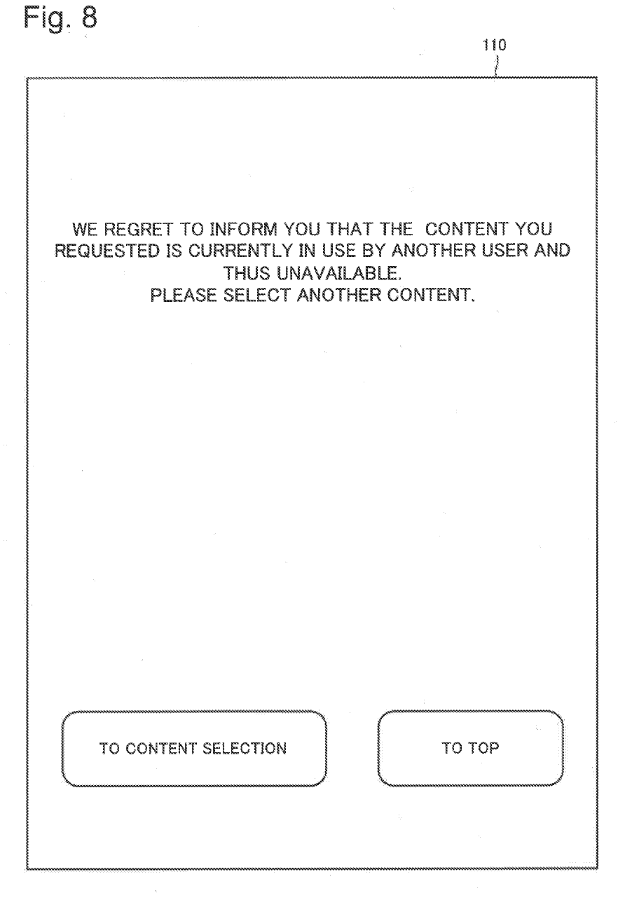

Upon receiving the instruction, the candidate device 12 shows, through a screen 110 as illustrated in FIG. 8, a message for reporting to a user that the content is currently unavailable (step S135).

In accordance with the screen 110, the user may operate to select another content or to move to an initial screen of a service to change to using other services. The operations are not particularly limited, and various ways of operations are conceivable.

In this example, the count of current provision in the storage unit 102 is not updated.

As described above, according to the content control device 100 in this example embodiment, the storage unit 102 stores the allowed count of current provision and the count of current provision of the object content, and the provision determination unit 104 determines, on the basis of the allowed count of current provision and the count of current provision, whether the object content can be provided to the candidate device 12 that receives the provided object content. When the count of current provision is less than or equal to the allowed count of current provision, the provision determination unit 104 determines the object content as providable to the candidate device 12. When the object content is provided to the candidate device 12 in accordance with the determination result, the provision count management unit 106 adds the count of current provision stored in relation to the object content. Accordingly, the count of current provision of the object content being provided to the candidate device 12 that is stored in the storage unit 102 is updated, and then the updated count of current provision is used when determining whether the object content can be provided in the next case.

In this manner, according to the content control device 100 in this example embodiment, the provision of the object content exceeding the permitted number of instances for current provision of content can be prohibited. At present, actual magazines that have been purchased are placed in waiting areas of hair salons or hospitals, cafes and the like to provide a meaningful time there. According to this example embodiment, such a scene can be achieved with digital content. Further, according to this example embodiment, the count of current provision of the object content can be restricted to the allowed count of current provision. Therefore, the problem of copyright in achieving digital content can be resolved.

### Second Example Embodiment

Next, a content control device and a control method according to a second example embodiment of the present invention will be described below. A program of this example embodiment causes at least one computer to execute a control method for a content control device in a similar manner to the above example embodiment, and a detailed description will be omitted in this example embodiment.

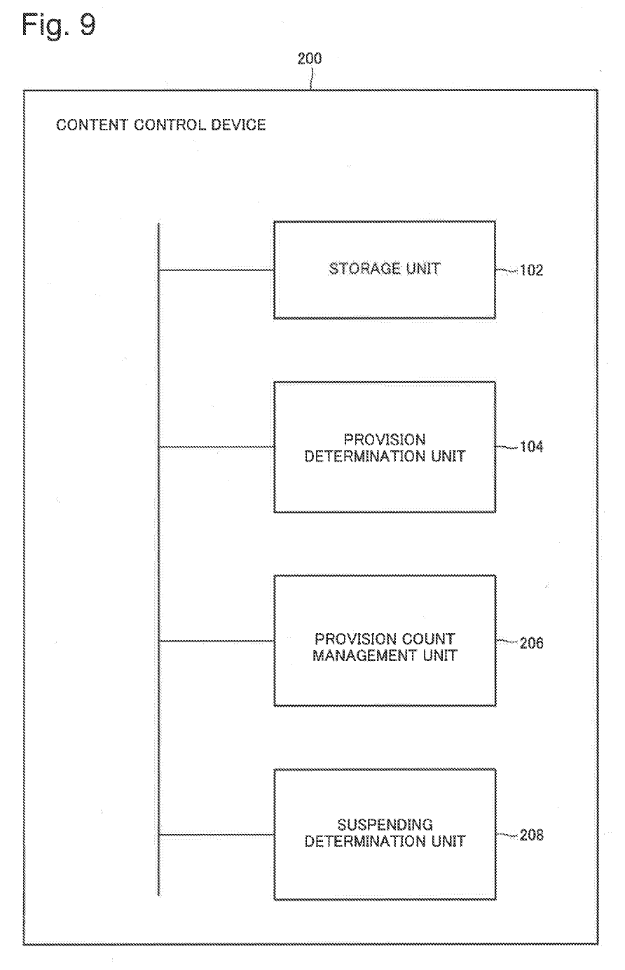

FIG. 9 is a functional block diagram illustrating the logical configuration of a content control device 200 according to the example embodiment of the present invention.

The content control device 200 of this example embodiment further includes a configuration such that the use of digital content provided to the candidate device 12 is suspended by the content control device 100 according to the above example embodiment.

The content control device 200 includes the storage unit 102 and the provision determination unit 104 in a similar manner to the content control device 100 according to the above example embodiment in FIG. 2, and further includes a provision count management unit 206 and a suspension determination unit 208.

The content control device 200 further includes the suspension determination unit 208 that determines whether to suspend the use of the object content being provided to the candidate device 12.

The provision count management unit 206 of this example embodiment controls in such a way that the object content that has been determined to be suspended by the suspension determination unit 208 is not used by the candidate device 12, and subtracts the count of current provision of the object content.

The details of the process by the provision count management unit 206 to suspend the use of the object content include, for example, a process of rendering the object content unusable for the candidate device 12. For example, when the candidate device 12 is a projector or the like, there may be an instruction to the service providing device 10 to change an image transmitted to the candidate device 12 from the service providing device 10 to an image of a cover of an electronic book, so that the electronic book is in a state where the inside cannot be read. Alternatives include an instruction to the service providing device 10 to suspend the provision of content, an indication to the content management server 14 to suspend the provision of content, and an indication to the candidate device 12 to suspend the use of content. When the candidate device 12 is a mobile terminal, alternatives include an indication to delete the object content from the mobile terminal, an instruction to change to prohibiting the use of the object content on the mobile terminal, and the like.

With the provision count management unit 206 subtracting from the count of current provision, the storage unit 102 can store the number of instances of the object content being currently provided simultaneously. In the case where the object content has not been providable due to the count of current provision already having reached the allowed count of current provision of the object content, the termination of provision of the object content causes the count of current provision to decrease and change to less than or equal to the allowed count of current provision. Therefore, the object content becomes providable to another user or on another occasion.

The control method for the content control device 200 according to this example embodiment configured in this manner will be described below.

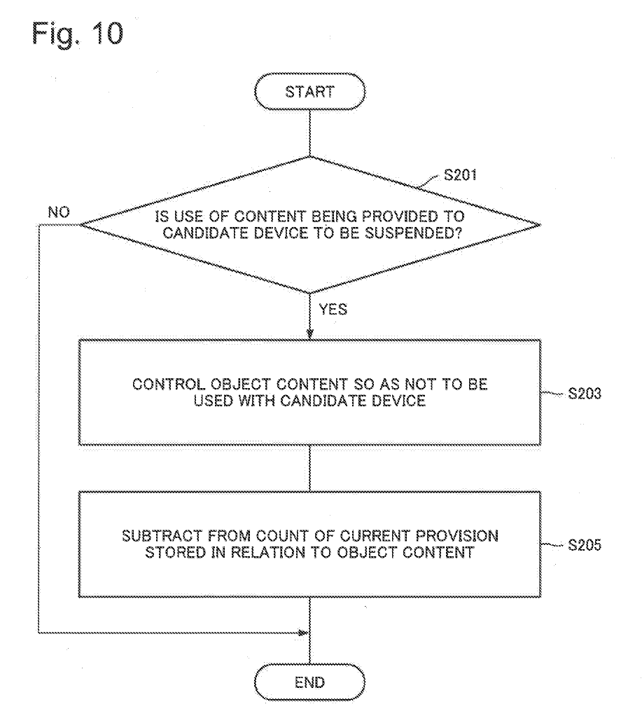

FIG. 10 is a flowchart illustrating one example of the operation of the content control device 200 according to this example embodiment.

In the control method of this example embodiment, the content control device 200 determines whether to suspend the use of the object content being provided to the candidate device 12 (step S201). The content control device 200 controls in such a way that the object content that has been determined to be suspended is not used by the candidate device 12 (step S203). The content control device 200 subtracts from the count of current provision of the object content (step S205).

The process procedure of this diagram is repeatedly executed regularly, as necessary, or at a predetermined timing, while the object content is being provided to the candidate device 12 or while the object content is being used.

Accordingly, in the case of a situation where the use of the object content should be suspended (YES in step S201), the object content can be controlled so as not to be used with the candidate device 12 (step S203). There is a subtraction from the count of current provision stored with respect to the object content (step S205).

In step S201, the suspension determination unit 208 may determine whether to suspend the use of the object content in accordance with an instruction to terminate the use by a user that has been using the object content via the candidate device 12.

As described above, in the content control device 200 according to this example embodiment, the suspension determination unit 208 determines whether to suspend the use of the object content being provided to the candidate device 12 regularly, as necessary, or at a predetermined timing, while the object content is being provided to the candidate device 12. The provision count management unit 206 controls in such a way that the object content that has been determined to be suspended by the suspension determination unit 208 is not used by the candidate device 12 and subtracts the count of current provision of the object content. Accordingly, the count of current provision of the object content being provided to the candidate device 12 that is stored in the storage unit 102 is updated, and then the updated count of current provision is used when determining whether the object content can be provided.

In this manner, with the content control device 200 of this example embodiment, an advantageous effect similar to the above example embodiment can be obtained. The content control device 200 of this example embodiment can further determine whether to suspend the use of the object content, and, in the case where suspension has been determined, control the object content so as not to be used by the candidate device 12. Thus, the content control device 200 of this example embodiment can manage content such that the content is used more appropriately.

### Modification of Second Example Embodiment

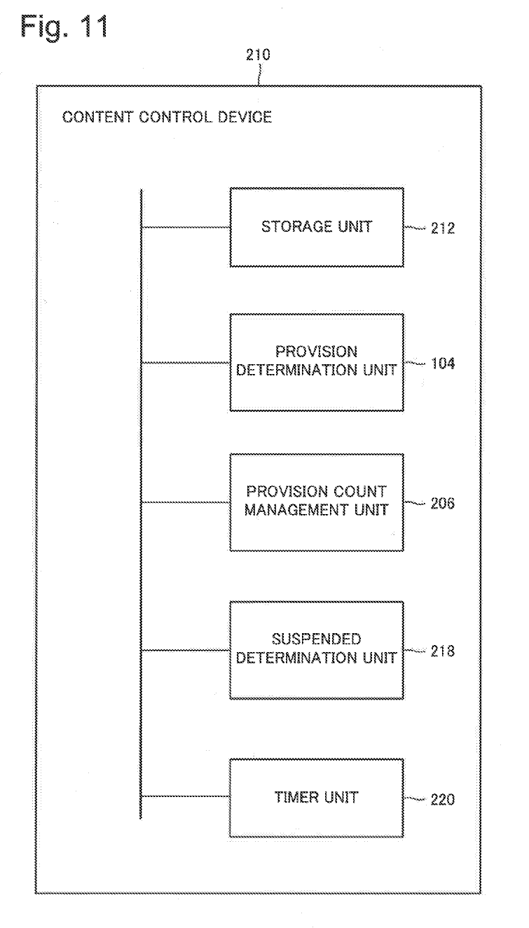

FIG. 11 is a functional block diagram illustrating the logical configuration of a content control device 210 of this example embodiment.

The content control device 210 of this example embodiment determines whether to suspend the use of the object content, carried out in the content control device 200, on the basis of the allowed time of use.

The content control device 210 includes the provision determination unit 104 and the provision count management unit 206 in a similar manner to the content control device 200 in FIG. 9, and further includes a storage unit 212, a suspension determination unit 218, and a timer unit 220.

The content control device 210 of this example embodiment further includes the timer unit 220 that measures the time of use of the object content being used by the candidate device 12.

In the content control device 210, the storage unit 212 further stores, for each content, the allowed time of use of the content. The suspension determination unit 218 determines, on the basis of the time of use of object content and the allowed time of use relating to the object content, whether to suspend the use of the object content being provided to the candidate device 12.

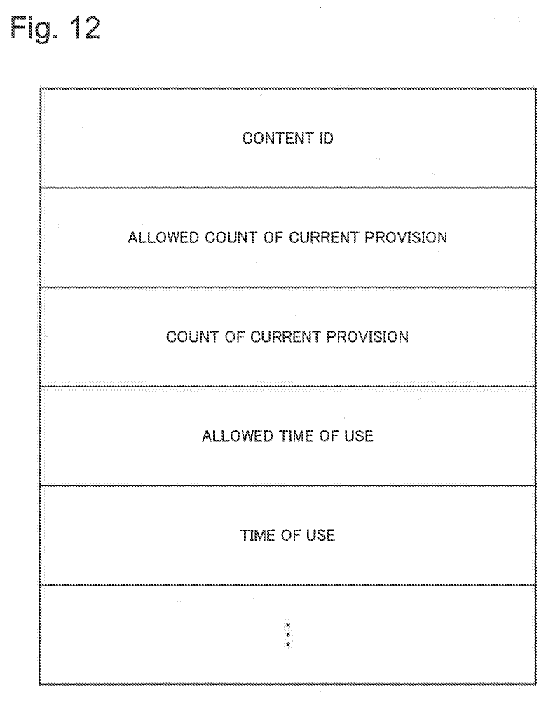

As illustrated in FIG. 12, the storage unit 212 may further store, for each content, the time of use and the allowed time of use in association with identification information (ID) of the content. The information may be stored in the ROM 64, the RAM 66, or storage (not illustrated) of the computer 60 in FIG. 3. FIG. 12 illustrates that storing is in the same table as for the allowed count of current provision and the count of current provision illustrated in FIG. 4. However, the table structure is not limited as such, and it is not necessary that the information is stored in a table format. The information may be stored as a parameter, variable, or the like.

In this example embodiment, the time of use refers to, for example, the time measured by the timer unit 220 from the time at which the object content has been provided to the candidate device 12 in accordance with a request for use of the object content or the start time of use or execution of the object content by a user via the candidate device 12. The time of use may be the time for which the object content has been actually used or executed, or a period during which the object content is provided including the time for which the object content is not used or executed may be measured and acquired by the timer unit 220. In other words, it may be the time from the start of provision of the object content up to the termination or suspension of the provision or the time from the start of use of the object content up to the termination or suspension of the use.

The allowed time of use refers to the time (period) for which a user can use the object content. For example, it may be such that 30 minutes from the start of use is the allowed time of use, or one week from the start of distribution or the acquisition of the license of the object content is the allowed time of use. It may be a restriction on the time available to one user (or in one unit of use for uses in games or the like in which a plurality of users play together) or may be a restriction on the time available in total (or for each unit of use) to a plurality of users. In other words, various types are conceivable for the timing to start measurement of or the condition of the allowed time of use.

In the case where the object content is music or a video, it may be the number of times played (the number of times of instruction to start playing or the number of times a track has been played to the end), the number of tracks (number of titles) played, the number of artists, the number of albums, or the like. It may also be the number of times a game has been played.

In this example embodiment, the time of use and the allowed time of use are stored for “each content”, but not limited to that. In the case where the content is a magazine, same magazines which sales month are different with each other can be treated as the same content and a common allowed time of use may be stored for them, or the time of use may be measured as different contents for each month of sale. For music, a common allowed time of use may be stored for a plurality of tracks within an album of the same artist or having one title that are treated as the same content, and the time of use can be measured for each track. Such setting and processing may be pursuant to the terms of license.

The timer unit 220 may be included in the content control device 100, while in other example embodiments, the candidate device 12 that uses content may include the timer unit 220.

In this example embodiment, the suspension determination unit 218 suspends the use of the object content when the time of use of the object content measured by the timer unit 220 has exceeded the allowed time of use relating to the object content that is stored in the storage unit 212. On the other hand, when the time of use of the object content is within the allowed time of use, the use of the object content is not suspended under this condition.

The control method for the content control device 210 of this example embodiment configured in this manner will be described below.

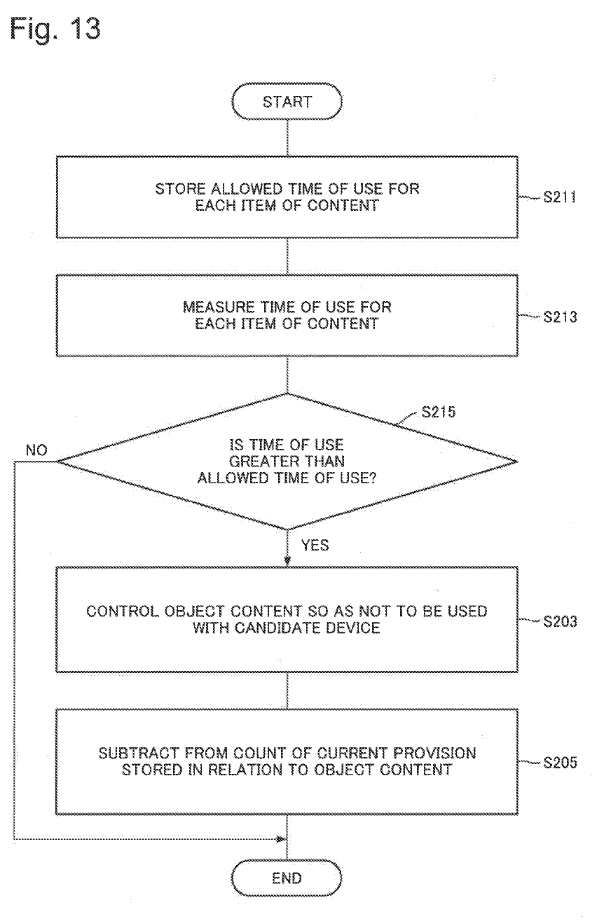

FIG. 13 is a flowchart illustrating one example of the operation of the content control device 210 of this example embodiment.

In the flowchart in FIG. 13, the process for a case where the suspension of the use of content has been determined by the suspension determination unit 218 is similar to step S203 and step S205 in the flowchart in FIG. 10.

In the control method in this example embodiment, the content control device 210 further stores, for each content, the allowed time of use of the content (step S211) and measures the time of use of the object content used by the candidate device 12 (step S213). The content control device 210 determines, on the basis of the measured time of use by the candidate device 12 and the allowed time of use relating to the object content, whether to suspend the use of the object content being provided to the candidate device 12 (step S215).

In the case of the time of use having exceeded the allowed time of use in step S215 (YES in step S215), the process proceeds to step S203 to suspend the use of the object content. In the case of the time of use being less than or equal to the allowed time of use (NO in step S215), the use of the object content is not suspended, and thus this process is terminated.

In this diagram, the process of step S213 and thereafter is repeatedly executed while the object content is being provided to the candidate device 12 or while the object content is being used by a user. The processes may be repeatedly executed for each of the object content, each of the candidate device 12, or each of the user.

As described above, in the content control device 210 of this example embodiment, the suspension determination unit 208 determines to suspend the use of the object content when the time of use of the object content has exceeded the allowed time of use with respect to the object content. In this case, in the content control device 210 of this example embodiment, the suspension determination unit 208 determines to suspend the use of the object content, even when the count of current provision of the object content is less than or equal to the allowed count of current provision.

In this manner, according to the content control device 210 of this example embodiment, the suspension of the use of the object content can be determined with the time of use of the object content, and the object content can be appropriately used for a limited period or the like.

### Third Example Embodiment

Next, a content control device and a control method according to a third example embodiment of the present invention will be described below.

A program of this example embodiment causes at least one computer to execute a control method for a content control device in a similar manner to the above example embodiment, and a detailed description will be omitted in this example embodiment.

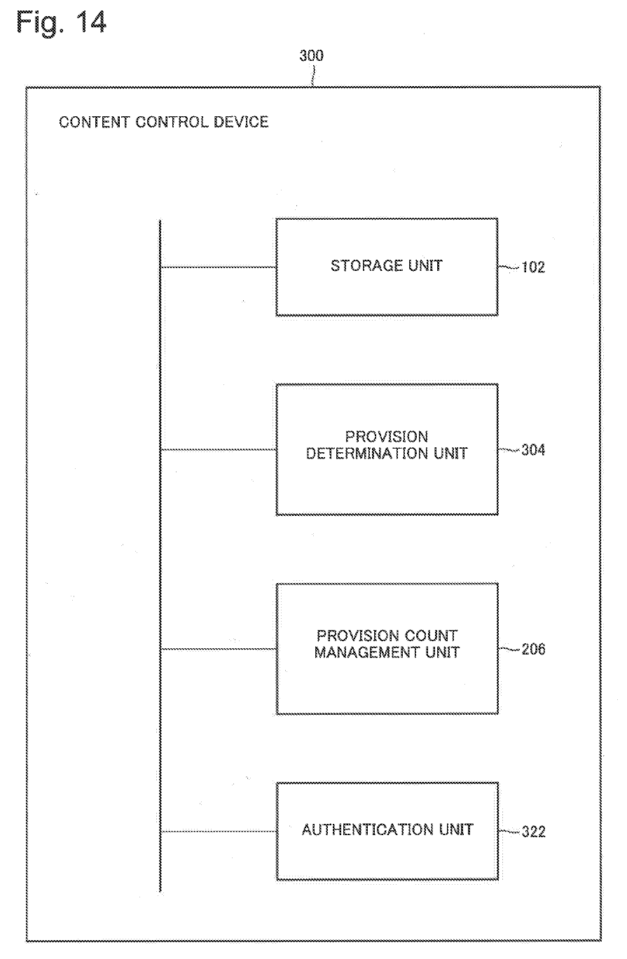

FIG. 14 is a functional block diagram illustrating the logical configuration of a content control device 300 according to the example embodiment of the present invention.

The content control device 300 of this example embodiment differs from the content control device 200 of the above example embodiment in that there is a further configuration to authenticate the candidate device 12 on condition of being present in a specific area and determine whether the object content can be provided in accordance with the authentication state.

FIG. 14 illustrates a configuration of the content control device 300 of this example embodiment using an example of a combination with the configuration of the content control device 200 in FIG. 9. However, combination may be with the configuration of the content control device 100 in FIG. 2, or the content control device 210 in FIG. 11. Alternatively, combination may be with a configuration of another example embodiment described later, unless there is inconsistency.

The content control device 300 includes the storage unit 102 and the provision count management unit 206 in a similar manner to the content control device 200 in FIG. 9 and further includes a provision determination unit 304 and an authentication unit 322.

The content control device 300 of this example embodiment further includes the authentication unit 322 that authenticates the candidate device 12 on condition of being present within a specific area and registers information of the candidate device 12 which is authenticated.

The provision determination unit 304 determines whether the object content can be provided with respect to the candidate device 12 of which the information is registered.

In this example embodiment, the specific area includes a relatively broad range such as a public place, a shop, a shopfront, or a floor and a relatively narrow range such as an imaging range of at least one camera or a communication range of at least one access point. An example using a camera will be described in detail in a later example embodiment, and therefore a detailed description will be omitted in this example embodiment.

There are various conceivable methods for the authentication unit 322 to determine whether the candidate device 12 is present within the specific area. For example, whether the presence is within the specific area can be determined on the basis of information (such as position registration information of a GPS (Global Positioning System) or base station) indicating a presence position of the candidate device 12. Alternatively, a communication range for communication between the candidate device 12 and an access point for Wi-Fi (Wireless Fidelity) communication, communication with the candidate device 12 through visible light communication for detection, or the like may be specified as the specific area for determination. the content control device 100 may further include an acquisition unit (not illustrated) that acquires information of communication situation, and on the basis of the information relating to the communication situation acquired by the acquisition unit, the authentication unit 322 determines whether the candidate device 12 is present within a specific area or not. Alternatively, it may be possible that a camera takes an image of the candidate device 12, the imaging range is specified as a specific area, and the authentication unit 322 determines whether the candidate device 12 is present within the specific area from the taken image.

In this example embodiment, the provision determination unit 304 permits the provision of the object content to the candidate device 12 of which information of authentication is registered by the authentication unit 322. On the other hand, the provision determination unit 304 prohibits the provision of object content to the candidate device 12 of which the information of authentication is not registered by the authentication unit 322.

The registration of information by the authentication unit 322 can be stored in the ROM 64, the RAM 66, or storage (not illustrated) of the computer 60 in FIG. 3. The information to be registered is, for example, identification information of the candidate device 12, e.g., an IP (Internet

Protocol) address, a MAC (Media Access Control) address, a UUID (Universally Unique Identifier), or the like. User information of the candidate device 12 that has been set may be stored. Alternatively, information indicating an authentication state may be stored in association with the identification information of the candidate device 12.

The control method for the content control device of this example embodiment configured in this manner will be described below.

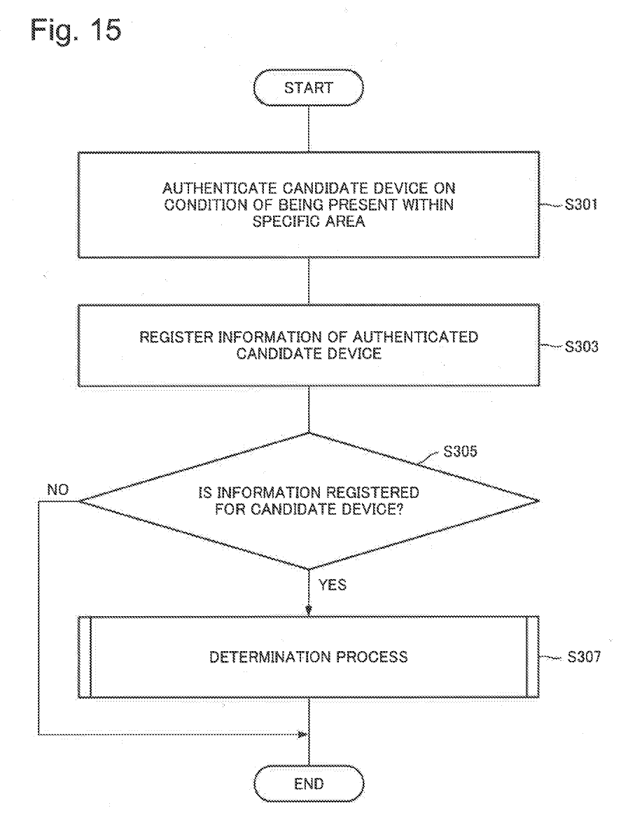

FIG. 15 is a flowchart illustrating one example of the operation of the content control device 300 of this example embodiment.

The control method according to the example embodiment of the present invention is a control method for the content control device 300, and is a control method executed by the computer 60 (FIG. 3) achieving the content control device 300.

In the control method of this example embodiment, the content control device 300 authenticates the candidate device 12 on condition of being present within a specific area (step S301), and registers information of the candidate device 12 which is authenticated (step S303). The content control device 300 determines, for the candidate device 12 of which information is registered (YES in step S305), whether the object content can be provided (step S307).

For the candidate device 12 of which information is not registered (NO in step S305), this process is terminated.

In step S307, the determination processes by the determination unit according to respective conditions, which are described in another example embodiment, may be respectively carried out as appropriate. The determination process is described in detail in another embodiment, and therefore a detailed description will be omitted in this example embodiment.

As described above, in the content control device 300 according to this example embodiment, the authentication unit 322 authenticates the candidate device 12 on condition of being present within a specific area, and the provision determination unit 304 permits the provision of the object content to the candidate device 12 of which information of authentication is registered. The provision determination unit 304 prohibits the provision of the object content to the candidate device 12 of which information of authentication is not registered by the authentication unit 322.

In this manner, with the content control device 300 according to this example embodiment, an advantageous effect similar to the above example embodiment can be obtained. Further, the provision of content can be controlled appropriately on condition that the presence is within a specific area, in the case where the object content is to be provided to the candidate device 12 present within the specific area and the provision of the content is not to be carried out in other areas.

### Modification of Third Example Embodiment

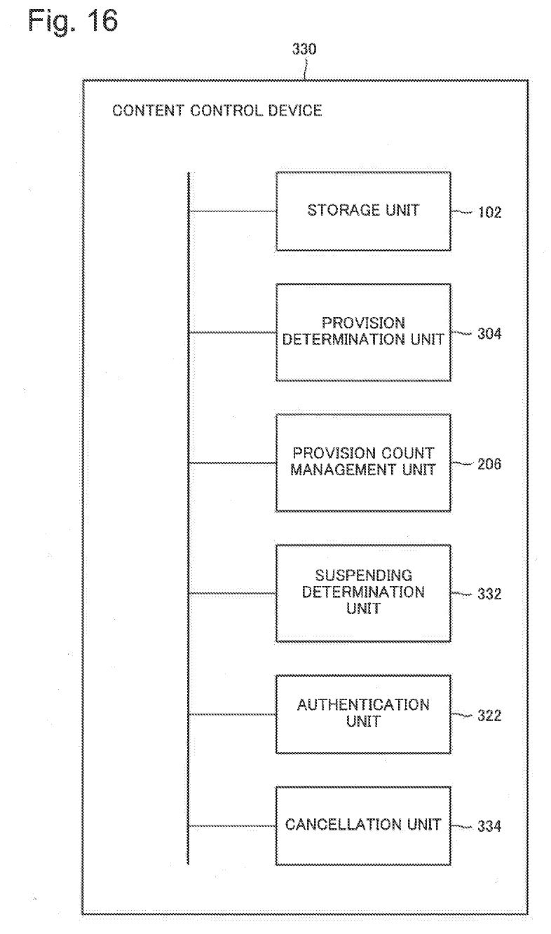

FIG. 16 is a functional block diagram illustrating the logical configuration of a content control device 330 according to this example embodiment.

The content control device 330 of this example embodiment further includes a configuration to cancel the registration of information of the candidate device 12 in the content control device 300.

The content control device 330 of this example embodiment includes the storage unit 102, the provision determination unit 304, the provision count management unit 206, and the authentication unit 322 in a similar manner to the content control device 300 of the above example embodiment in FIG. 14, and further includes a suspension determination unit 332 and a cancellation unit 334.

The content control device 330 of this example embodiment further includes the cancellation unit 334 that cancels the registration of information of the candidate device 12 which is authenticated. The suspension determination unit 332 determines to suspend the use of the object content being provided to the candidate device 12 for which the registration of information has been cancelled.

For example, the cancellation unit 334 cancels the registration of the information of the candidate device 12 which is authenticated, in the case where the candidate device 12 of which the information is registered by the authentication unit 322 has no longer been present in the specific area.

As described above, the cancellation unit 334 determines, on the basis of position information of the candidate device 12, that the candidate device 12 out of the specific area is not present in the specific area. The cancellation unit 334 may determine whether the candidate device 12 is present in the specific area on the basis of information such as the communication situation between the candidate device 12 and an access point or the like, or determination may depend on whether the candidate device 12 appears in an image taken by a camera, that is, whether the candidate device 12 is included in the imaging range of the camera (corresponding to the specific area).

The above process of detecting whether the candidate device 12 is present within a specific area or out of the specific area may be repeatedly executed regularly, as necessary, or at a predetermined timing. Accordingly, the candidate device 12 that had been present within a specific area has exited from the specific area can be detected regularly, as necessary, or at a predetermined timing.

As the cancellation of registration of information, information that the authentication unit 322 has registered may be deleted from the ROM 64, the RAM 66, or storage (not illustrated) of the computer 60 in FIG. 3, or information indicating the authentication state that is stored in association with identification information of the candidate device 12 may be changed from authenticated to unauthenticated.

The operation of the content control device 330 of this example embodiment configured in this manner will be described below.

Herein, when non-presence in the specific area has been determined by the authentication unit 322 in step S301 of the flowchart in FIG. 15 described in the above example embodiment, the cancellation unit 334 cancels the registration of the information of the candidate device 12 (not illustrated). In step S305, the suspension determination unit 332 determines that information of the candidate device 12 is not registered (NO in step S305). In this case, the operation proceeds to step S201 in FIG. 10 to carry out the process of suspending the use of content.

In the content control device 330 of this example embodiment configured in this manner, the suspension determination unit 332 can determine, in response to the cancellation of the registration of the information of the candidate device 12 which is authenticated by the cancellation unit 334, whether to suspend the use of the object content being provided to that candidate device 12. In the content control device 330, the suspending of the use of the object content, which has no longer been in the specific area, can be determined.

In this manner, according to the content control device 330 of this example embodiment, an advantageous effect similar to the above example embodiment can be obtained. Further, the object content that has been provided to the candidate device 12 that has no longer been present in a specific area can be appropriately rendered unusable for that candidate device 12.

### Fourth Example Embodiment

Next, a content control device according to a fourth example embodiment of the present invention will be described below. A control method and a program of this example embodiment causes at least one computer to execute a control method for a content control device in a similar manner to the above example embodiment, and a detailed description will be omitted in this example embodiment.

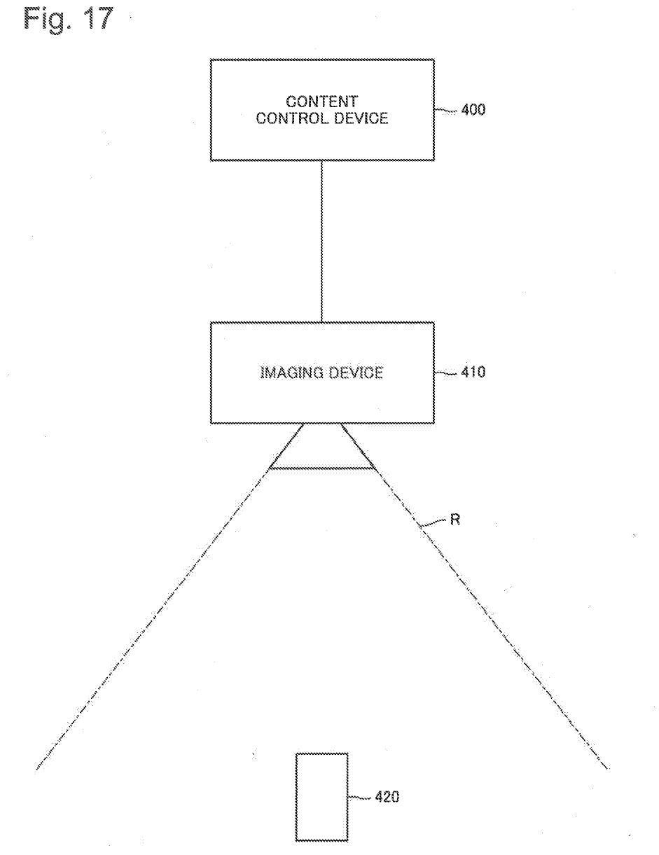

FIG. 17 is a diagram schematically illustrating a system configuration of a content providing system including a content control device 400 of this example embodiment.

The content providing system of this example embodiment includes the content control device 400, an imaging device 410, and a mobile terminal (the candidate device 12 is hereinafter assumed as a smartphone in this example embodiment) 420. The imaging device 410 can take an image in an imaging range R, takes an image of the mobile terminal 420 present within the imaging range R, and outputs the image which is taken.

In the content control device 400 of this example embodiment, an authentication unit (not illustrated) authenticates, on the basis of the image taken by the imaging device 410, the mobile terminal 420 (candidate device 12) present in the imaging range R of the imaging device 410.

The authentication process by the authentication unit may be carried out regularly. With carrying out regularly, the authentication of a mobile terminal that has no longer been present in a specific area can be cancelled.

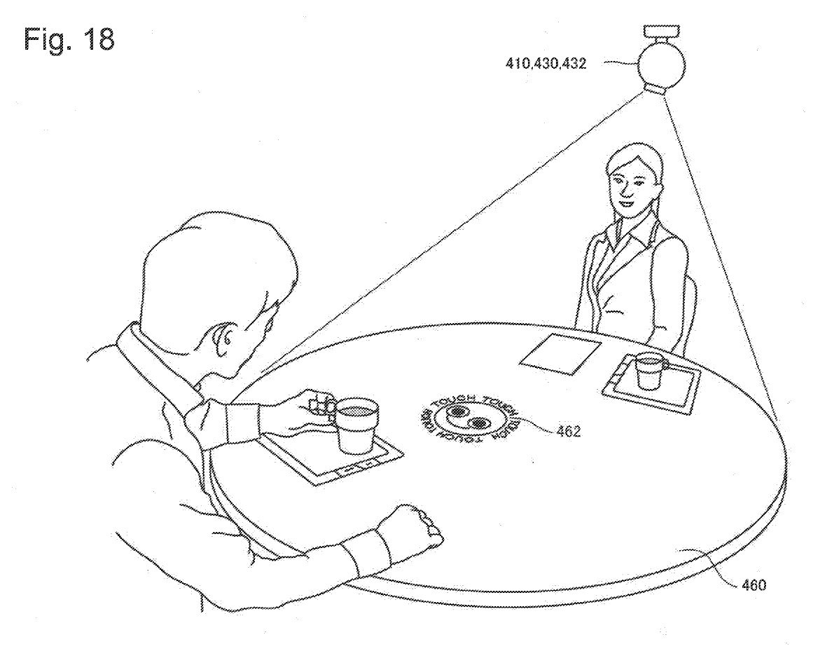

FIG. 18 is a view illustrating an example in which a projection image 462 is projected, by a projection device 430, onto a table 460 which a user is using. Herein, the table 460 as a projection surface onto which the projection image 462 is projected by the projection device 430 is included in the imaging range R of the imaging device 410 in FIG. 17. By arranging the mobile terminal 420 in the imaging range R and carrying out a predetermined operation, the imaging device 410 takes an image of the mobile terminal 420, and the authentication unit detects, on the basis of the obtained image, the presence of the mobile terminal 420 in the specific area to authenticate the mobile terminal 420.

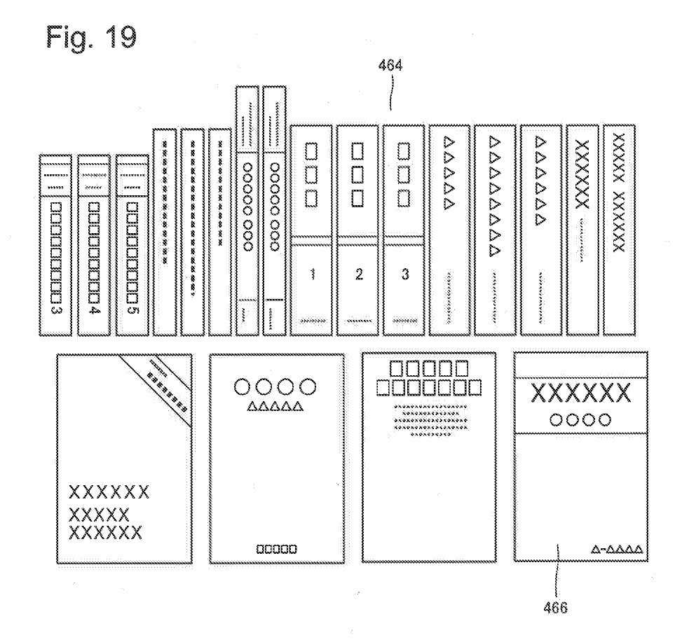

The projection device 430 may project an image 464 of a bookshelf, as illustrated in FIG. 19, onto the table 460. Below the image 464 of the bookshelf, images 466 of the covers of a plurality of electronic books included in the bookshelf may be aligned and projected.

By a three-dimensional sensor 432 in FIG. 18, an operation with respect to the projection image (464 or 466) by a user can be detected. Through a combination of the projection device 430 and the three-dimensional sensor 432, the projection device 430 as the candidate device 12 projects the image 464 of the bookshelf as in FIG. 19 onto the table 460. The projection device 430 as the candidate device 12 accepts a selection of the electronic book to be browsed by a user from the bookshelf, by detecting an operation of the user on the image 466 through the three-dimensional sensor 432. In this configuration, the termination of browsing a corresponding electronic book can be accepted through an operation by a user on the image.

When the provision and use of the object content selected by a user is permitted by the content control device 400, the projection device 430 projects an image of the object content of the electronic book onto the table 460. Through such operation, the user can browse the electronic book with the image projected onto the table 460.

A method for using the object content includes projection of an inside of the electric book onto the table 460 for browsing by the user, or providing the object content of the electronic book to the authenticated mobile terminal 420 for use on the mobile terminal 420.

The content control device 400 further includes a cancellation unit (not illustrated) that cancels the registration of information of the authenticated mobile terminal 420. The suspension determination unit 332 determines to suspend the use of the object content being provided to the mobile terminal 420 for which the registration of information has been cancelled.

In this example embodiment, the authentication unit includes an acquisition unit (not illustrated), a generation unit (not illustrated), a second identifier output unit (not illustrated), a detection unit (not illustrated), and a terminal authentication unit (not illustrated). The acquisition unit (not illustrated) acquires, from the mobile terminal 420 within the specific area, a first identifier of that mobile terminal 420. The generation unit (not illustrated) generates a second identifier of the mobile terminal 420 corresponding to the first identifier. The second identifier output unit (not illustrated) transmits the generated second identifier of the mobile terminal 420 to the mobile terminal 420 and causes that mobile terminal 420 to visually present the second identifier. The detection unit (not illustrated) detects the second identifier presented by the mobile terminal 420 from an image taken by the imaging device 410. The terminal authentication unit (not illustrated) specifies the first identifier corresponding to the detected second identifier and authenticates the mobile terminal 420 corresponding to the specified first identifier as being present in the specific area.

The second identifier is an identifier for identifying one or a plurality of the mobile terminals 420 possibly included in the imaging range R of the imaging device 410. The first identifier is, as described in the above example embodiment, an identifier for identifying the mobile terminal 420, whether or not possibly included in the imaging range R of the imaging device 410.

The second identifier output unit displays a string or image representing the second identifier on a display screen included in the mobile terminal 420. The image representing the second identifier may be an image directly representing the second identifier or may be an image representing a symbol encoding the second identifier. When the second identifier is a numerical sequence of “1234,” for example, the “image directly representing the second identifier” is an image visually representing the numerical sequence of “1234.” The “symbol encoding the second identifier” is a barcode, a two-dimensional code, or the like converted from a value represented by the second identifier.

The second identifier output unit may, for example, visually present the second identifier by causing blinking with a light source included in the mobile terminal 420 in a pattern based on the second identifier. The light source of the mobile terminal 420 in this case may be a light source (such as a backlight) configuring the display screen, may be a light source (of LED (Light Emitting Diode) light or the like) provided separately from the display screen, or may be a light source provided for visible light communication. The second identifier output unit presents information through a combination of turning on and turning off of the light source.

This configuration allows a mobile terminal such as the mobile terminal 420 to be authenticated for being present in a specific area without carrying out user registration in advance or the like to provide the object content for use by the mobile terminal 420.

For example, by a user visiting a shop presenting the mobile terminal 420 to a camera and carrying out the authentication process, the object content that can be purchased and provided at the shop can be made usable to the user within the range of the number of licenses, through projection or the like with the mobile terminal 420 or a projector. In the case where the user has exited from the shop, the authentication state is cancelled, and the use of the object content is suspended.

### Modification of Fourth Example Embodiment

A modification of the fourth example embodiment will be described below.

This example embodiment further includes an authentication unit (not illustrated) that authenticates the mobile terminal 420 present in the imaging range R of the imaging device 410, using an image taken by the imaging device 410, and registers information of the authenticated mobile terminal 420.

The candidate device 12 may include the projection device 430 (FIG. 18) that projects an image for a user of the authenticated mobile terminal 420.

A determination unit determines whether the object content can be provided with respect to the projection device 430 that projects an image for the user of the mobile terminal 420 of which information is registered.

With this configuration, for a user of the mobile terminal 420 which is authenticated, the projection device 430 that projects an image for the use of the object content can be made as the candidate device 12, and the use of the object content in the candidate device 12 can be controlled.

Example embodiments of the present invention have been described above with reference to the drawings. However, these illustrates examples of the present invention, and various configurations other than the above may be employed.

### Suspending of the Object Content Outside Specific Area

In the above example embodiment, when the candidate device 12 is a mobile terminal, there are cases such that a function, which informs the mobile terminal of a situation where the mobile terminal itself that has been using the object content cannot use the object content, is required. For example, in the fourth example embodiment, a user coming out of a shop with a mobile phone falls out of a specific area in which the use of object content is permitted. Therefore, the use of object content in the mobile terminal needs to be suspended.

However, when the mobile terminal is out of the shop, there may be a possibility that the control from the content providing system 1 such as the content control device 100 or the service providing device 10 does not reach the mobile terminal. Accordingly, there may be a possibility that the use of the object content being used with the mobile terminal cannot be suspended.

Thus, for example, the mobile terminal may include a control unit (not illustrated). The control unit allows the use of the object content on condition that, upon the use of the object content, information relating to the permission of use of the object content has been received from the content control device 100, the service providing device 10, or the content management server 14.

The control unit may be achieved by a dedicated application installed in the mobile terminal for use of digital content. Alternatively, upon the use of the object content, the control unit may query the content control device 100, the service providing device 10, or the content management server 14 for the permission of use of the object content, and allow the use of the object content in the case of an approval.

The determination by the control unit is preferably carried out regularly during the use of the object content. It is advisable that the configuration be capable of dealing with changes in availability due to movement of a mobile terminal.

In the case where permission information of the object content cannot be acquired, the control unit of a mobile terminal suspends the use of the object content that has been used, and the deletes digital content off the mobile terminal or does not permit the use of the object content.

According to this configuration, the object content being used with a mobile terminal can be rendered unusable, when the mobile terminal that had been present within a specific area and using the object content has moved out of the specific area. In other words, the object content being used with the mobile terminal can be reliably rendered unusable when the control from the content providing system 1 side does not reach the mobile terminal.

### Management of Current Provision Within Specific Area

For the content control device of the above example embodiment, a configuration has been described in which, for example, whether or not the mobile terminal is present in the imaging range R of one camera, the communication range of an access point, or the like as a specific area is detected, and whether the object content can be provided within the specific area is determined. In other examples, the configuration may be such that, with imaging ranges of a plurality of cameras as the specific area, the simultaneous use of the object content within the plurality of imaging ranges is managed. When a plurality of cameras have been installed in a certain shop, all imaging ranges of the plurality of cameras may be the specific area, or the configuration may be such that a plurality of specific areas depending on the camera are set and the count of current provision of the object content are managed for each of the specific area.

The plurality of cameras may be connected to an STB (Set Top Box), and further the configuration may be such that a plurality of STBs are installed in a shop. In this case, the specific area may be set for each of the STB to manage the count of current provision of the object content.

In this manner, there are various conceivable units of ranges to manage the count of current provision. For example, that unit of ranges to manage may be the imaging range of at least one camera, the communication range of at least one access point or the like, a range for a camera or access point connected to at least one STB, a shop, a floor, a selling space, a combination thereof, or the like.

### Acquisition of Situation of Use of Content

The content control device of any one of the above example embodiments may further includes an acquisition unit (not illustrated) that acquires information of a request for use of the content from the candidate device 12 and information on the situation of use of the content in the candidate device 12 with respect to that request for use.

The situation of use of the content includes information such as the number of times or frequency, with respect to a request for use of the content, that the content has not been providable to a candidate device.

With this configuration, the number of times the content has not been provided to the candidate device 12 despite the acceptance of a request for use is calculated on the basis of the information on the situation of use acquired by the acquisition unit. A shop or the like may consider increasing the number of licenses when the number of the times is greater than or equal to a predetermined value, stopping purchase thereafter of those for which the number of times of a request for use is less than or equal to a predetermined value (which may differ from the predetermined value described above), or the like.

### Transfer of the Object Content Between Mobile Terminals

As a modification of the above fourth example embodiment, a configuration is conceivable in which the object content being used by an authenticated mobile terminal can be transferred to another authenticated mobile terminal. The modification may be configured in such a way that the count of current provision is not added after the transfer. In the case where the use with the source mobile terminal is continuing, it is preferable that the count of current provision is added.

For example, assume that at least two mobile terminals are placed on the table 460, and both of the mobile terminals are authenticated by an authentication unit 402. Assume that the object content is yet to be used with a second mobile terminal, and the object content has already been used with a first mobile terminal. When a user carries out a gesture on the table 460 to transfer the object content to the second mobile terminal from the first mobile terminal, the three-dimensional sensor 432 detects the gesture. In response to the gesture, the provision count management unit 206 carries out a process of transferring the object content that has been used with the first mobile terminal for use with the second mobile terminal. For example, the use of the object content is suspended in the first mobile terminal, and the use of the object content is permitted in the second mobile terminal. In this case, the count of current provision of the object content is not updated.

In the case where the use of the object content is not suspended in the first mobile terminal, the provision determination unit 304 determines whether the object content can be provided to the second mobile terminal on the basis of the allowed count of current provision and the count of current provision. When the object content is determined as providable, the second mobile terminal is permitted to use the object content. In this case, the count of current provision of the object content is added by the provision count management unit 206.

The invention of this application has been described above with reference to the example embodiments and practical examples. However, the invention of this application is not limited to the above example embodiments and practical examples. For the configuration and details of the invention of this application, various modification can be made comprehensible to a person skilled in the art within the scope of the invention of this application. In the case of acquiring or using information relating to a user in the present invention, it is to be carried out legally.

This application claims priority from Japanese Patent Application No. 2014-113005 filed on May 30, 2014, the entire disclosure of which is incorporated herein by reference.

Below are supplementary notes on examples of a reference embodiment.

1. A control method for a content control device, wherein the content control device

stores, for each content, a provided count and a providable count of the content, the provided count being instance count of the content being provided at a given point in time,

determines whether to provide a object content to a candidate device being subject to receive the object content based on the provided count and the providable count, and

adds the provided count stored with respect to the object content when the object content is provided to the candidate device in accordance with the determination result.

2. The control method for a content control device according to 1.,

wherein the content control device

determines whether to suspend use of the object content being provided to the candidate device,

controls the object content that has been determined to be suspended so as not to be used by the candidate device, and subtracts the provided count of the object content.

3. The control method for the content control device according to 2.,

wherein the content control device

measures time of the use of the object content being used by the candidate device,

further stores, for each of the content, an allowed time of the use of the content, and

determines whether to suspend the use of the object content being provided to the candidate device based on the time of the use of the object content and the allowed time of use with respect to the object content.

4. The control method for the content control device according to 2. or 3.,

wherein the content control device

authenticates the candidate device on condition of being present within a specific area and registers information of the authenticated candidate device, and

wherein the content control device

determines whether the object content can be provided, regarding the candidate device of which the information is registered.

5. The control method for the content control device according to 4.,

wherein the content control device

cancels registration of the information of the authenticated candidate device, and

determines to suspend the use of the content being provided to the candidate device for which registration of the information has been cancelled.

6. The control method for the content control device according to 4.,

wherein the content control device

authenticates the candidate device present in an imaging range of an imaging device based on an image taken by the imaging device.

7. The control method for the content control device according to 2. or 3.,

wherein the content control device

authenticates a mobile terminal present in an imaging range of an imaging device using an image taken by the imaging device, and registers information of the authenticated mobile terminal,

wherein the candidate device includes a projection device that projects an image for a user of the authenticated mobile terminal, and

wherein the content control device

determines whether the object content can be provided regarding the projection device that projects the image for the user of the mobile terminal of which the information is registered.

8. The control method for the content control device according to 7.,

wherein the content control device

cancels registration of the information of the authenticated mobile terminal, and

determines to suspend the use of the content being provided to the mobile terminal for which registration of the information has been cancelled.

9. The control method for a content control device according to any one of 1. to 8.,

wherein the content control device

acquires information of a request for use of the content from the candidate device and information on a situation of use of the content in the candidate device with respect to the request for use.

10. A program for causing a computer achieving a content control device to execute:

a procedure of storing, for each content, a provided count and a providable count of the content, the provided count being instance count of the being provided at a given point in time;

a procedure of determining whether to provide a object content to a candidate device being subject to receive the based on the provided count and the providable count; and

a procedure of adding the provided count stored with respect to the object content when the object content is provided to the candidate device in accordance with a result the determination.

11. The program according to 10. for causing the computer to further execute:

a procedure of determining whether to suspend use of the object content being provided to the candidate device; and

a procedure of controlling the object content that has been determined to be suspended by the procedure of determining whether to suspend so as not to be used by the candidate device and subtracting the provided count of the object content.

12. The program according to 11. for causing the computer to further execute:

a procedure of measuring time of the use of the object content being used via the candidate device;

a procedure of further storing, for each of the content, an allowed time of the use of the content; and

a procedure of determining whether to suspend the use of the object content being provided to the candidate device based on the time of the use of the object content and the allowed time of use with respect to the object content.

13. The program according to 11. or 12.,

wherein the computer is caused to further execute a procedure of authenticating the candidate device on condition of being present within a specific area and registering information of the authenticated candidate device; and

wherein a computer is caused to further execute a procedure of determining whether the object content can be provided, regarding the candidate device of which the information is registered.

14. The program according to 13. for causing the computer to further execute:

a procedure of cancelling registration of the information of the authenticated candidate device; and

a procedure of determining to suspend the use of the content being provided to the candidate device for which registration of the information has been cancelled.

15. The program according to 13. for causing the computer to further execute

a procedure of authenticating the candidate device present in an imaging range of an imaging device, based on an image taken by the imaging device.

16. The program according to 11. or 12.,

wherein the computer is caused to further execute a procedure of authenticating a mobile terminal present in an imaging of an imaging device using an image taken by the imaging device, and registering information of the authenticated mobile terminal,

wherein the candidate device includes a projection device that projects an image for a user of the authenticated mobile terminal, and

wherein a computer is caused to further execute a procedure of determining whether the object content can be provided regarding the projection device that projects the image for the user of the mobile terminal for which the information is registered.

17. The program according to 16. for causing the computer to further execute:

a procedure of cancelling registration of the information of the authenticated mobile terminal; and

a procedure of determining to suspend the use of the content being provided to the mobile terminal for which registration of the information has been cancelled.

18. The program according to any one of 10. to 17. for causing a computer to further execute

a procedure of acquiring information of a request for use of the content from the candidate device and information on a situation of use of the content in the candidate device with respect to the request for use.

### REFERENCE SIGNS LIST

1 Content providing system
10 Service providing device
12 Candidate device
14 Content management server
16 Content server
60 Computer
62 CPU
64 ROM
66 RAM
69 Bus
70 Program
100 Content control device
102 Storage unit
104 Provision determination unit
106 Provision count management unit
110 Screen
200 Content control device
206 Provision count management unit
208 Suspension determination unit
210 Content control device
212 Storage unit
218 Suspension determination unit
220 Timer unit
300 Content control device
304 Provision determination unit
310 Content control device
322 Authentication unit
330 Content control device
332 Suspension determination unit
334 Cancellation unit
400 Content control device
402 Authentication unit
404 Cancellation unit
410 Imaging device
420 Mobile terminal
430 Projection device
432 Three-dimensional sensor
460 Table
462 Projection image

1. A content control device comprising:
a processor configured to function as
storage unit configured to store, for each content, a provided count and a providable count of the content, the provided count representing instance count of the content being provided at a given point in time;
provision determination unit configured to determine whether to provide a object content to a candidate device being subject to receive the object content based on the provided count and the providable count; and
provision count management unit configured to add instance count of the object content newly provided to the provided count stored with respect to the object content when the object content is provided to the candidate device in accordance with a determination result from the provision determination unit.

2. The content control device according to claim 1,
the processor further configured to function as suspension determination unit configured to determine whether to suspend use of the object content being provided to the candidate device,
wherein the provision count management unit controls to disallow the use of the object content by the candidate device that has been determined to be suspended by the suspension determination unit, and subtracts the instance count of the object content of which use has been disallowed from the provided count of the object content.

3. The content control device according to claim 2,
the processor further configured to function as timer unit configured to measure time of the use of the object content being used by the candidate device,
wherein the storage unit further stores, for each of the content, an allowed time of the use of the content, and
the suspension determination unit determines whether or not to suspend the use of the object content being provided to the candidate device based on the time of the use of the object content and the allowed time of use with respect to the object content.

4. The content control device according to claim 2,
further comprising authentication unit configured to authenticate the candidate device when the candidate device is present within a specific area and registering information of the authenticated candidate device,
wherein the provision determination unit determines whether the object content can be provided with respect to the candidate device of which the information is registered.

5. The content control device according to claim 4,
the processor further configured to function as authentication cancellation unit configured to cancel registration of the information of the candidate device which is authenticated,
wherein the suspension determination unit determines to suspend the use of the content being provided to the candidate device for which registration of the information has been cancelled.

6. The content control device according to claim 4,
wherein the authentication unit authenticates, based on an image taken by an imaging device, the candidate device present in a range with which the image taken has been taken.

7. The content control device according to claim 2,
the processor further configured to function as authentication unit configured to authenticate, using an acquired image taken by an imaging device, a mobile terminal present in a range with which the image taken has been taken and registering information of an authenticated mobile terminal,
wherein the candidate device includes a projection device that projects an image for a user of the authenticated mobile terminal, and
the provision determination unit determines whether the object content can be provided regarding the projection device that projects the image for the user of the mobile terminal of which the information is registered.

8. The content control device according to claim 7,
the processor further configured to function as authentication cancellation unit configure to cancel registration of the information of the authenticated mobile terminal,
wherein the suspension determination unit determines to suspend the use of the content being provided to the mobile terminal for which registration of the information has been cancelled.

9. The content control device according to claim 1,
the processor further configured to function as acquisition unit configured to acquire information of a request for use of the content from the candidate device and information on a situation of use of the content in the candidate device with respect to that request for use.

10. A control method for a content control device, comprising:
storing, for each content, a provided count and a providable count of the content, the provided count representing instances count of the content being provided at a given point in time;
determining whether to provide a object content to a candidate device being subject to receive the object content based on the provided count and the providable count; and
adding instance count of the object content newly provided to the provided count stored with respect to the object content when the object content is provided to the candidate device in accordance with a result the determination.

11. A non-transitory computer-readable recording medium storing a program causing a computer achieving a content control device to execute:
a procedure of storing, for each content, a provided count and a providable count of the content, the provided count representing instance count of the content being provided at a given point in time;
a procedure of determining whether to provide a object content to a candidate device being subject to receive the object content based on the provided count and the providable count; and
a procedure of adding instance count of the object content newly provided to the provided count stored with respect to the object content when the object content is provided to the candidate device in accordance with a result the determination.
